(19) United States
(12) Patent Application Publication
(10) Pub. No.: US 2010/0157203 A1
(43) Pub. Date: Jun. 24, 2010

(54) COLD CATHODE DISCHARGE TUBE AND MANUFACTURING METHOD THEREOF AND LIQUID CRYSTAL DISPLAY DEVICE

(75) Inventor: Kazumasa HIRAI, Mobara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignees: Hitachi Display Devices, Ltd.; Hitachi Displays, Ltd.

(21) Appl. No.: 12/640,303

(22) Filed: Dec. 17, 2009

(30) Foreign Application Priority Data
Dec. 22, 2008 (JP) 2008-325845

(51) Int. Cl. G02F 1/1335; H01J 9/38; H01J 1/62

(52) U.S. Cl. 349/70; 445/38; 313/493

(57) ABSTRACT

Provided is a manufacturing method for a cold cathode discharge tube including: preparing a plurality of glass tubes each having a phosphor layer formed on an inner surface thereof and joining the glass tubes together at ends thereof, to thereby form a bent glass tube having a bent tube portion; fitting electrodes to both ends of the bent glass tube; and filling gas inside of the bent glass tube.

### CROSS-REFERENCE TO RELATED APPLICATION

The present application claims priority from Japanese application JP 2008-325845 filed on Dec. 22, 2008, the content of which is hereby incorporated by reference into this application.

### BACKGROUND OF THE INVENTION

1. Field of the Invention

The present invention relates to a cold cathode discharge tube, a manufacturing method for the cold cathode discharge tube, and a liquid crystal display device.

2. Description of the Related Art

There has been known that a cold cathode discharge tube is used for a backlight of a liquid crystal display device (JP 2007-188649 A). Further, it is conceivable to use a cold cathode discharge tube in a bent state.

When an attempt is made to manufacture a cold cathode discharge tube having a bent configuration by preparing a straight cold cathode discharge tube and then bending the tube, there arises such a problem that a production line corresponding to a length of the original straight cold cathode discharge tube is required.

### SUMMARY OF THE INVENTION

The present invention has an object to enable a cold cathode discharge tube having a bent configuration to be manufactured in a small space.

(1) A manufacturing method for a cold cathode discharge tube according to the present invention includes: preparing a plurality of glass tubes each having a phosphor layer formed on an inner surface thereof and joining the plurality of glass tubes together at ends thereof, to thereby form a bent glass tube having a bent tube portion; fitting electrodes to both ends of the bent glass tube; and filling gas inside of the bent glass tube. According to the present invention, the cold cathode discharge tube having a bent configuration may be manufactured in a small space because the plurality of glass tubes are joined together to form the bent glass tube.

(2) In the manufacturing method for a cold cathode discharge tube according to Item (1), the bent glass tube may include a plurality of straight tube portions arranged in parallel to each other, and the bent tube portion may be so formed as to connect a pair of the straight tube portions to each other.

(3) In the manufacturing method for a cold cathode discharge tube according to Item (2), each of the plurality of glass tubes may be prepared in a state where a half of the bent tube portion is adjacent to the end and one of the plurality of straight tube portions is adjacent to the half of the bent tube portion.

(4) In the manufacturing method for a cold cathode discharge tube according to Item (1), the forming a bent glass tube may include preparing each of the plurality of glass tubes in a straight state, joining two of the plurality of glass tubes together at the ends, and then bending the two joined glass tubes.

(5) In the manufacturing method for a cold cathode discharge tube according to Item (1), the bent glass tube may include a plurality of first straight tube portions arranged in parallel to each other, and a second straight tube portion arranged to extend orthogonally between a pair of the first straight tube portions, and the bent tube portion may be formed to connect each of the pair of first straight tube portions and the second straight tube portion.

(6) In the manufacturing method for a cold cathode discharge tube according to Item (5), each of the plurality of glass tubes may be prepared in a state where a half of the second straight tube portion is adjacent to the end, the bent tube portion is adjacent to the half of the second straight tube portion, and one of the plurality of first straight tube portions is adjacent to the bent tube portion.

(7) In the manufacturing method for a cold cathode discharge tube according to any one of Items (1) to (6), each of the plurality of glass tubes may be prepared in a state where the phosphor layer is formed so as to avoid the joined end.

(8) A cold cathode discharge tube according to the present invention includes: a bent glass tube having a bent tube portion, the bent glass tube being formed by joining together a plurality of glass tubes each having a phosphor layer formed on an inner surface thereof; electrodes fitted to both ends of the bent glass tube; and gas filled inside of the bent glass tube. According to the present invention, the cold cathode discharge tube having a bent configuration may be manufactured in a small space because the bent glass tube having the plurality of glass tubes joined together is used.

(9) In the cold cathode discharge tube according to Item (8), the bent glass tube may include a plurality of straight tube portions arranged in parallel to each other, and the bent tube portion may be so formed as to connect a pair of the straight tube portions to each other.

(10) In the cold cathode discharge tube according to Item (9), the bent tube portion may include a joint portion of a pair of the glass tubes, and the phosphor layer may be formed so as to avoid the joint portion.

(11) In the cold cathode discharge tube according to Item (8), the bent glass tube may include a plurality of first straight tube portions arranged in parallel to each other, and a second straight tube portion arranged to extend orthogonally between a pair of the first straight tube portions, and the bent tube portion may be formed to connect each of the pair of first straight tube portions and the second straight tube portion.

(12) In the cold cathode discharge tube according to Item (11), the second straight tube portion may include a joint portion of a pair of the glass tubes, and the phosphor layer may be formed so as to avoid the joint portion.

(13) A liquid crystal display device according to the present invention includes: a liquid crystal display panel; and a backlight having a cold cathode discharge tube. In the liquid crystal display device, the cold cathode discharge tube includes: a bent glass tube having a bent tube portion, the bent glass tube being formed by joining together a plurality of glass tubes each having a phosphor layer formed on an inner surface thereof; electrodes fitted to both ends of the bent glass tube; and gas filled inside of the bent glass tube. According to the present invention, the cold cathode discharge tube having a bent configuration may be manufactured in a small space because the bent glass tube having the plurality of glass tubes joined together is used.

(14) In the liquid crystal display device according to Item (13), the bent glass tube may include a plurality of straight tube portions arranged in parallel to each other, and the bent tube portion may be so formed as to connect a pair of the straight tube portions to each other.

(15) In the liquid crystal display device according to Item (14), the bent tube portion may include a joint portion of a pair of the glass tubes, and the phosphor layer may be formed so as to avoid the joint portion.

(16) In the liquid crystal display device according to Item (13), the bent glass tube may include a plurality of first straight tube portions arranged in parallel to each other, and a second straight tube portion arranged to extend orthogonally between a pair of the first straight tube portions, and the bent tube portion may be formed to connect each of the pair of first straight tube portions and the second straight tube portion.

(17) In the liquid crystal display device according to Item (16), the second straight tube portion may include a joint portion of a pair of the glass tubes, and the phosphor layer may be formed so as to avoid the joint portion.

### BRIEF DESCRIPTION OF THE DRAWINGS

In the accompanying drawings:

FIG. 1 is a cross-sectional view illustrating a cold cathode discharge tube according to an embodiment of the present invention;

FIG. 2 is a cross-sectional view for describing a manufacturing method for the cold cathode discharge tube according to the embodiment of the present invention;

FIG. 3 is a cross-sectional view illustrating a cold cathode discharge tube according to a first modified example of the embodiment of the present invention;

FIG. 4 is a cross-sectional view for describing a manufacturing method for the cold cathode discharge tube according to the first modified example of the embodiment of the present invention;

FIG. 5 is a cross-sectional view illustrating a cold cathode discharge tube according to a second modified example of the embodiment of the present invention;

FIG. 6 is a cross-sectional view for describing a manufacturing method for the cold cathode discharge tube according to the second modified example of the embodiment of the present invention;

FIG. 7 is a cross-sectional view illustrating a cold cathode discharge tube according to a third modified example of the embodiment of the present invention;

FIG. 8 is a cross-sectional view for describing a manufacturing method for the cold cathode discharge tube according to the third modified example of the embodiment of the present invention;

FIG. 9 is an exploded perspective view illustrating a liquid crystal display device according to the embodiment of the present invention;

FIG. 10 is a diagram for describing a circuit of the liquid crystal display device according to the embodiment of the present invention;

FIG. 11 is a cross-sectional view illustrating a cold cathode discharge tube according to another modified example of the embodiment of the present invention; and

FIG. 12 is a cross-sectional view illustrating a cold cathode discharge tube according to still another modified example of the embodiment of the present invention.

### DETAILED DESCRIPTION OF THE INVENTION

Hereinafter, an embodiment of the present invention is described with reference to the accompanying drawings.

(Cold Cathode Discharge Tube)

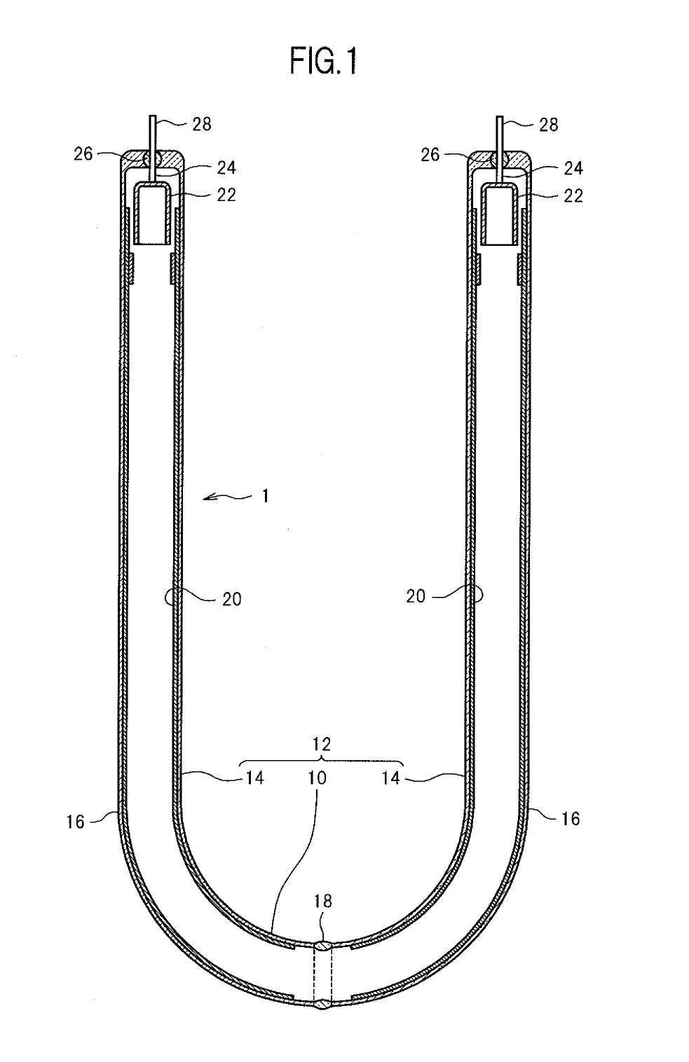

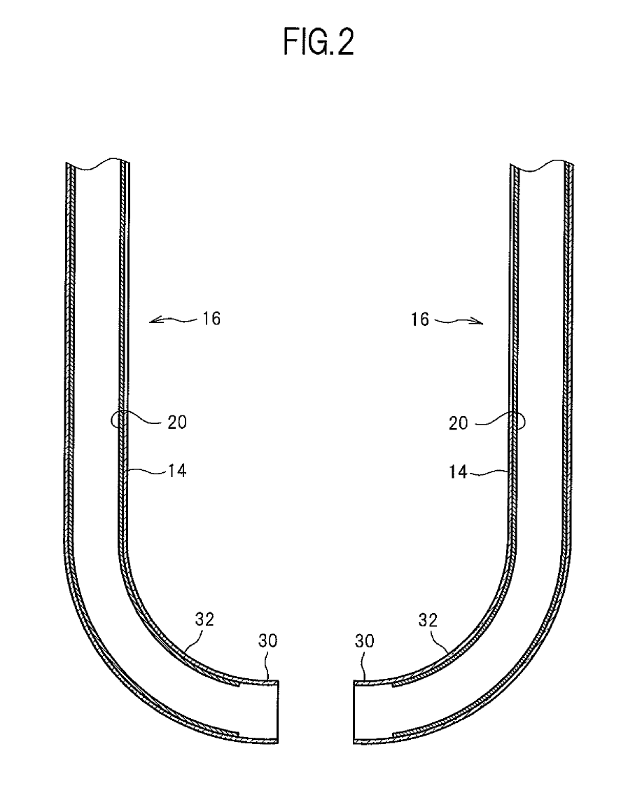

FIG. 1 is a cross-sectional view illustrating a cold cathode discharge tube according to an embodiment of the present invention. A cold cathode discharge tube 1 includes a bent glass tube 12 with a bent tube portion 10. The bent glass tube 12 is made of glass being a light transmissive material. The bent glass tube 12 includes a plurality of straight tube portions 14 arranged in parallel to each other. The bent tube portion 10 is so formed as to connect a pair of the straight tube portions 14. The bent glass tube 12 is formed by joining a plurality of glass tubes 16 (refer to FIG. 2) together, and a joint portion 18 of the pair of glass tubes 16 is located at the bent tube portion 10.

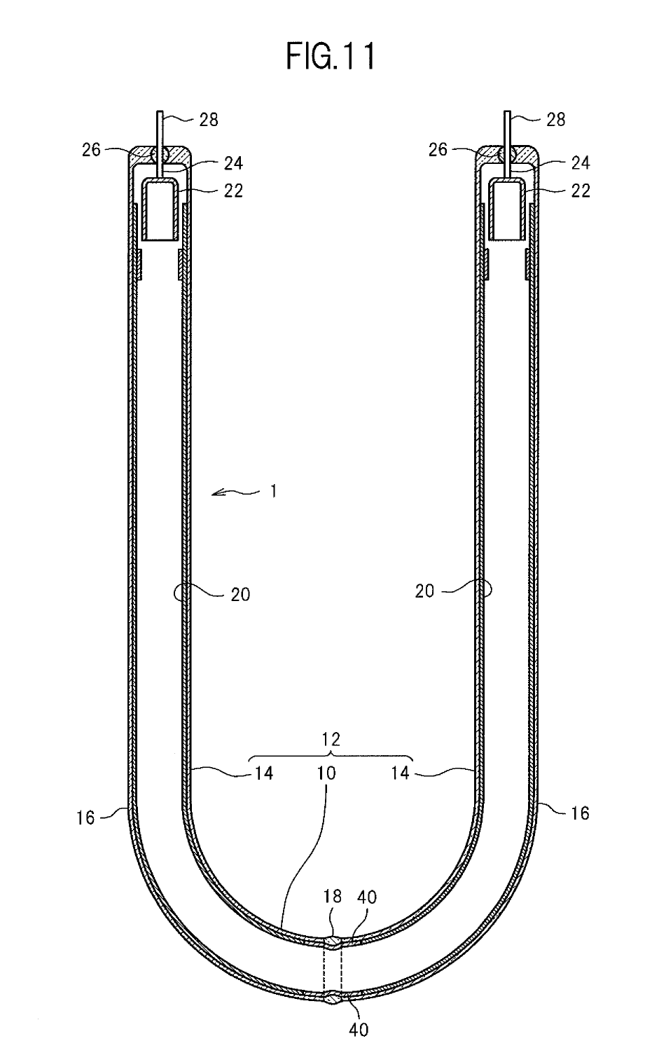

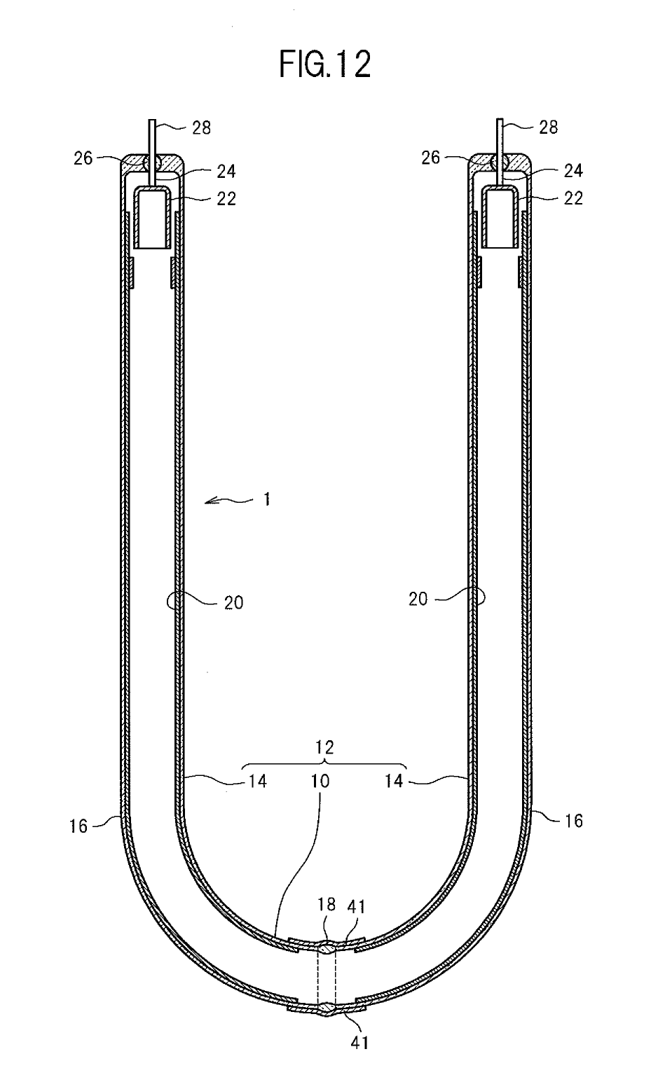

A phosphor layer 20 is formed on an inner surface of the bent glass tube 12. The phosphor layer 20 is formed so as to avoid the joint portion 18. In a region where the phosphor layer 20 is removed, as illustrated in FIG. 11, a layer 40 that shields ultraviolet rays may be coated on the bent glass tube 12 so as to prevent ultraviolet rays from being output from the joint portion 18. The layer 40 that shields ultraviolet rays may be formed by provision of a transparent film that reflects ultraviolet rays on the inner surface of the glass tube 16. Alternatively, as illustrated in FIG. 12, a member 41 that shields light may be wound on an outer surface of the glass tube 16. Also, it is effective that the joint portion 18 and a neighborhood thereof (a portion in which the phosphor layer 20 avoids being formed) are made of glass that shields ultraviolet rays.

Electrodes 22 are attached to both ends of the bent glass tube 12, respectively. The electrodes 22 may be made of a material mainly containing, for example, tungsten. Each of the electrodes 22 is cup-shaped, and an opening end of the cap faces a main discharge region (inside of the bent glass tube 12).

To a rear end of each electrode 22 (an end facing an outer direction of the bent glass tube 12) is provided an inner lead 24 made of an alloy of nickel, cobalt, and iron, with a characteristic close to the thermal expansion coefficient of glass. The electrodes 22 and the inner leads 24 are joined together through, for example, a resistance welding method, an arc welding method, or a laser welding method so as to be electrically connected to each other.

The inner leads 24 are each hermetically fitted to the bent glass tube 12 through a glass bead 26. The glass beads 26 are welded on both ends of the bent glass tube 12 to seal the bent glass tube 12. An outer lead 28 made of, for example, nickel material is joined to each inner lead 24 projecting outward from the glass bead 26 by welding or the like. Each outer lead 28 is connected to a power supply circuit (not shown) (generally, inverter lighting circuit) which supplies a lighting power between the pair of electrodes 22 which are attached to both ends of the bent glass tube 12.

A gas is filled in the interior of the bent glass tube 12. For example, neon-argon (Ne—Ar) gas and mercury are filled therein as an inactive gas.

According to this embodiment, the cold cathode discharge tube 1 having a bent configuration may be manufactured in a small space because the bent glass tube 12 having the plurality of glass tubes 16 joined together is used.

(Manufacturing Method for Cold Cathode Discharge Tube 1)

FIG. 2 is a cross-sectional view for describing a manufacturing method for a cold cathode discharge tube according to the embodiment of the present invention.

In a manufacturing method for the cold cathode discharge tube 1, there are prepared the plurality (two in FIG. 2) of glass tubes 16 each having the phosphor layer 20 formed in an inner surface thereof. Each of the glass tubes 16 has an end 30 for joining. A half bent tube portion 32 being a half of the bent tube portion 10 of the bent glass tube 12 as a complete product is adjacent to the end 30. The straight tube portion 14 is adjacent to the half bent tube portion 32 on a side opposite to the end 30. The phosphor layer 20 is formed on the glass tube 16 so as to avoid the joined end 30.

The two glass tubes 16 are joined together at the respective ends 30 to form the bent glass tube 12 having the bent tube portion 10. The joint is made so as to arrange the plurality of straight tube portions 14 in parallel. The half bent tube portions 32 are connected to each other to form the bent tube portion 10 that connects the pair of straight tube portions 14 to each other.

The bent glass tube 12 is thus formed. The bent glass tube 12 includes the plurality of straight tube portions 14 arranged in parallel to each other. The bent tube portion 10 is so formed as to connect the pair of straight tube portions 14 together.

The electrodes 22 are fitted to portions corresponding to both ends of the bent glass tube 12. For example, the bent glass tube 12 may be formed by joining the glass tubes 16 together after the electrodes 22 have been each fitted to the end 30 of the glass tube 16 on the side opposite to the end 30 for joining. Alternatively, the electrodes 22 may be each fitted to the end 30 of the bent glass tube 12 after the bent glass tube 12 has been formed. In any cases, at least one of the ends 30 to which the electrode 22 is fitted is vented in advance with an aim to execute vacuuming and gas filling to be performed subsequently.

Subsequently, gas is filled inside of the bent gas tube 12. In more detail, after the inside of the bent glass tube 12 has been vacuumed, neon-argon (Ne—Ar) gas and mercury are filled in the bent glass tube 12 as an inactive gas.

The manufacturing method for the cold cathode discharge tube 1 according to this embodiment includes a process obvious from the configuration of the above-mentioned cold cathode discharge tube 1 and a known manufacturing method for the cold cathode discharge tube 1, in addition to the above-mentioned process. According to this embodiment, the plurality of glass tubes 16 are joined together to form the bent glass tube 12, and hence the cold cathode discharge tube 1 having a bent configuration may be manufactured in a small space.

In the example illustrated in FIG. 2, the plurality of glass tubes 16 having the bent portions (half bent tube portions 32) are joined to each other. Alternatively, a plurality of straight glass tubes (straight tubes) may be joined to each other, and then an arbitrary portion (for example, a portion including a joint portion) thereof may be bent, to thereby form the bent glass tube 12 having the bent tube portion 10 illustrated in FIG. 1. Even in this case, at least the glass tubes (straight tubes) before being joined to each other have a length smaller than a total length of the bent glass tube 12, which enables easy handling.

### First Modified Example

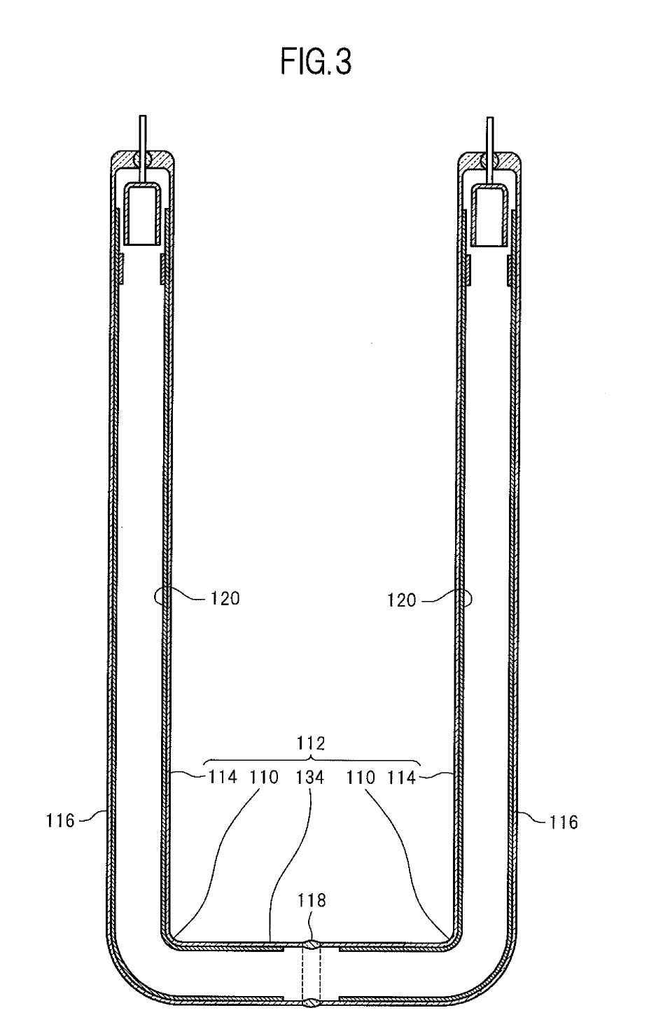

FIG. 3 is a cross-sectional view illustrating a cold cathode discharge tube according to a first modified example of the embodiment of the present invention.

A bent glass tube 112 includes a plurality of first straight tube portions 114 arranged in parallel to each other. The bent glass tube 112 includes a second straight tube portion 134 arranged to extend orthogonally between a pair of the first straight tube portions 114. Bent tube portions 110 are so formed as to connect each of the pair of first straight tube portions 114 and the second straight tube portion 134. That is, the bent tube portions 110 are located at both ends of the second straight tube portion 134. A joint portion 118 of the pair of glass tubes 116 is located at the second straight tube portion 134. A phosphor layer 120 is formed on the inner wall of the bent glass tube 112 so as to avoid the joint portion 118.

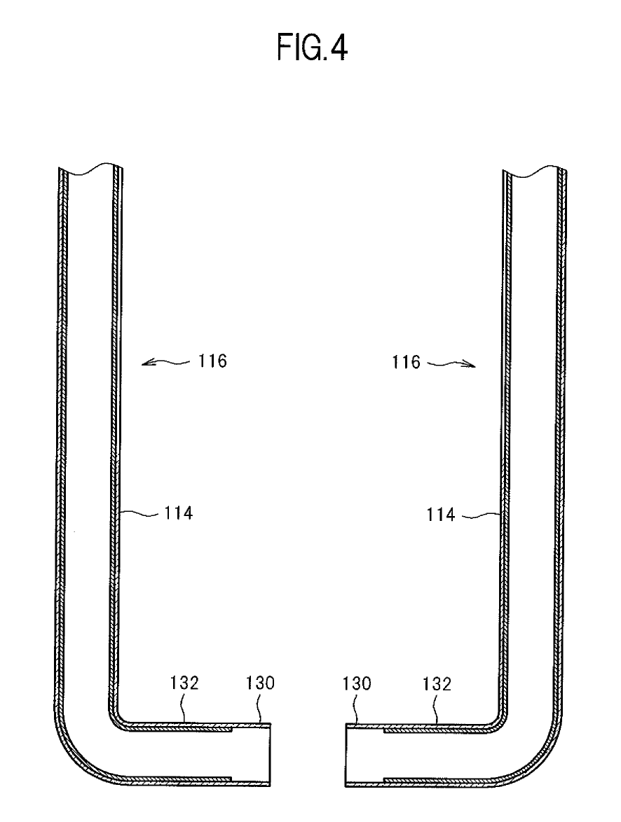

FIG. 4 is a cross-sectional view for describing a manufacturing method for the cold cathode discharge tube according to the first modified example of the present invention.

In each of the glass tubes 116 prepared in the first modified example, a half straight tube portion 132 being a half of the second straight tube portion 134 is adjacent to an end 130 for joining. The bent tube portion 110 is adjacent to the half straight tube portion 132 on a side opposite to the end 130 for joining. One of the first straight tube portions 114 is adjacent to the bent tube portion 110 on a side opposite to the half tube portion 132.

The details of the configuration and the manufacturing method of the first modified example correspond to the contents described in the above-mentioned embodiment.

### Second Modified Example

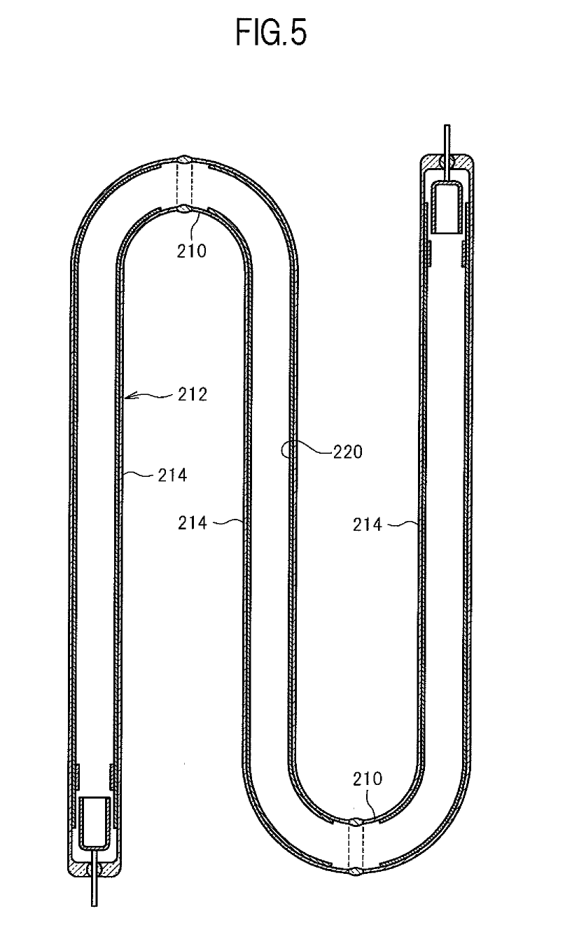

FIG. 5 is a cross-sectional view illustrating a cold cathode discharge tube according to a second modified example of the embodiment of the present invention. The second modified example is different from the above-mentioned embodiment in that the cold cathode discharge tube includes a bent glass tube 212 having a plurality of bent tube portions 210. Each of the bent tube portions 210 is so formed as to connect a pair of straight tube portions 214 to each other, respectively.

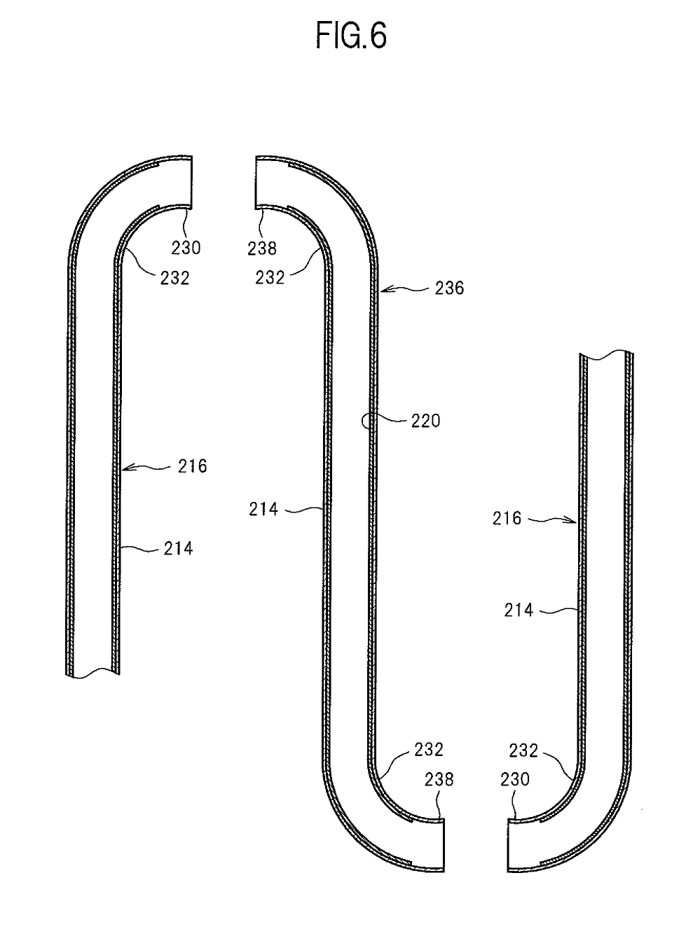

FIG. 6 is a cross-sectional view for describing a manufacturing method for the cold cathode discharge tube according to the second modified example of the embodiment of the present invention. In the second modified example, there are prepared a plurality of first glass tubes 216 and a second glass tube 236. The configuration of the first glass tube 216 corresponds to the contents of the glass tube 16.

The second glass tube 236 has second ends 238 for joining on both sides thereof. A half bent tube portion 232 being a half of one bent tube portion 210 of the bent glass tube 212 as a complete product is adjacent to the second end 238. The half bent tube portion 232 is adjacent to the straight tube portion 214 on a side opposite to the second end 238. A phosphor layer 220 is formed on the second glass tube 236 so as to avoid the second ends 238 for joining.

The second ends 238 of the second glass tube 236 are joined to an end 230 of one first glass tube 216 and an end 230 of another first glass tube 216, respectively, to form the bent glass tube 212 including the plurality of bent tube portions 210. The joint is so made as to arrange the plurality of straight tube portions 214 in parallel. The half bent tube portions 232 which are halves of the bent tube portion 210 are connected to each other to form the bent tube portion 210 connecting a pair of the straight tube portions 214.

The details of the configuration and the manufacturing method of the second modified example correspond to the contents described in the above-mentioned embodiment. In the example illustrated in FIG. 6, the three glass tubes having the bent portions (half bent tube portions 232) are joined to each other. Alternatively, three straight glass tubes may be used. In this case, two straight glass tubes (straight tubes) are joined to each other, and then an arbitrary portion (for example, a portion including a joint portion) thereof is bent. Thereafter, one straight glass tube is further joined to the bent glass tube, and then an arbitrary portion (for example, a portion including a joint portion) is then bent, to thereby form the bent glass tube having the two bent tube portions 210 illustrated in FIG. 5.

### Third Modified Example

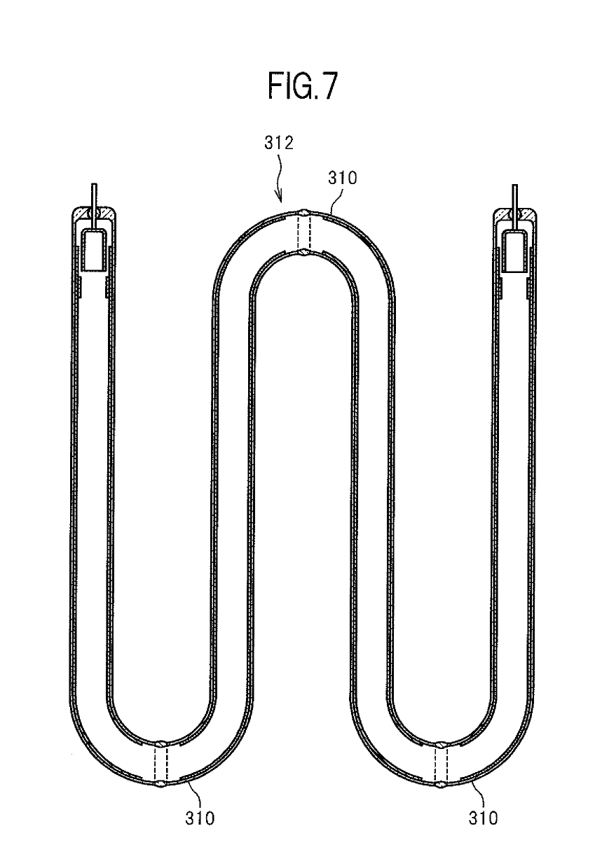

FIG. 7 is a cross-sectional view illustrating a cold cathode discharge tube according to a third modified example of the embodiment of the present invention. The third modified example is different from the above-mentioned embodiment and the second modified example in that the cold cathode discharge tube includes a bent glass tube 312 having three or more bent tube portions 310.

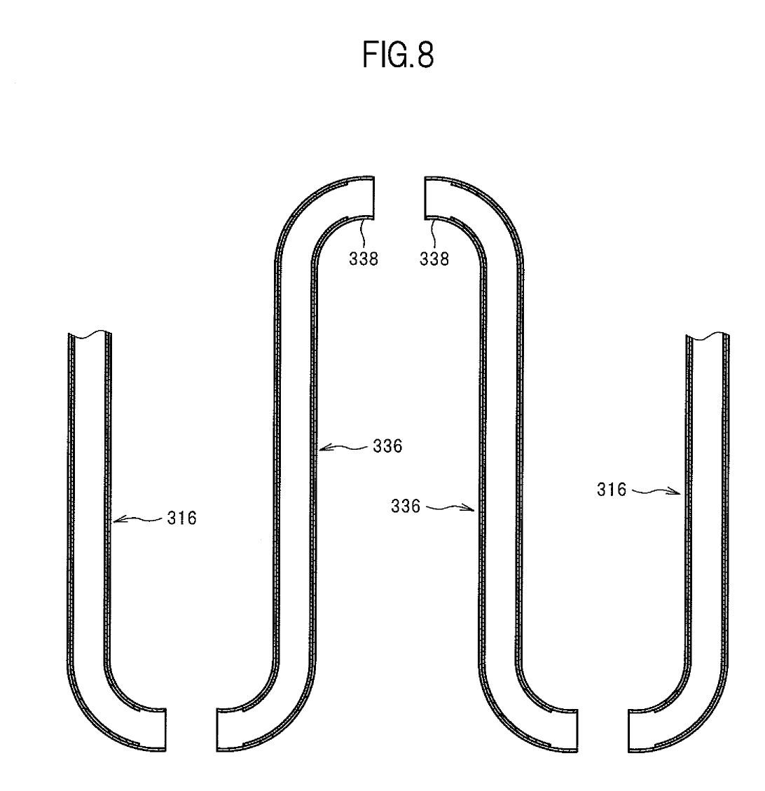

FIG. 8 is a cross-sectional view for describing a manufacturing method for the cold cathode discharge tube according to the third modified example of the embodiment of the present invention. In the above-mentioned second modified example, one second glass tube 236 is arranged between the pair of first glass tubes 216, and in the third modified example, a plurality of second glass tubes 336 are arranged between a pair of first glass tubes 316. In the third modified example, there are prepared the pair of first glass tubes 316 and the plurality of second glass tubes 336. The configuration of the first glass tube 316 is identical with that of the glass tube 16 described in the above-mentioned embodiment. The configuration of the second glass tube 336 is identical with that of the second glass tube 236 described in the above-mentioned second modified example. The joint of the first glass tube 316 and the second glass tube 336 is identical with the joint of the first glass tube 216 and the second glass tube 236 described in the second modified example. In the third modified example, a second end 338 of one second glass tube 336 is joined to a second end 338 of another second glass tube 336.

The details of the configuration and the manufacturing method of the third modified example correspond to the contents described in the above-mentioned embodiment.

(Liquid Crystal Display Device)

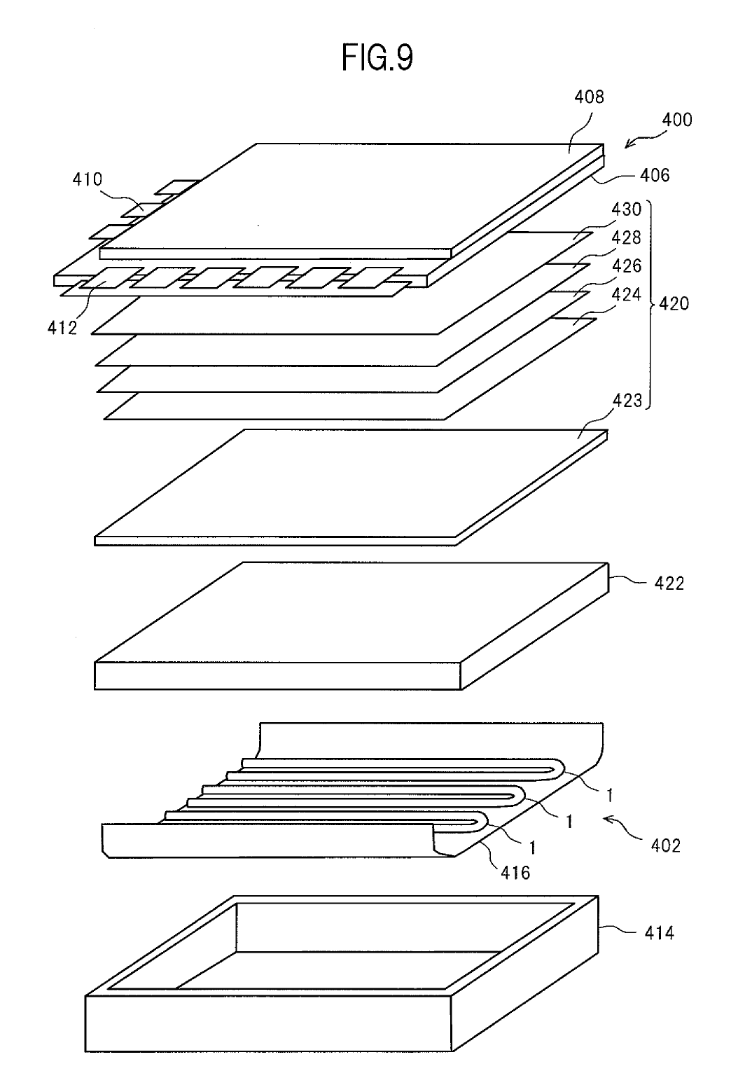

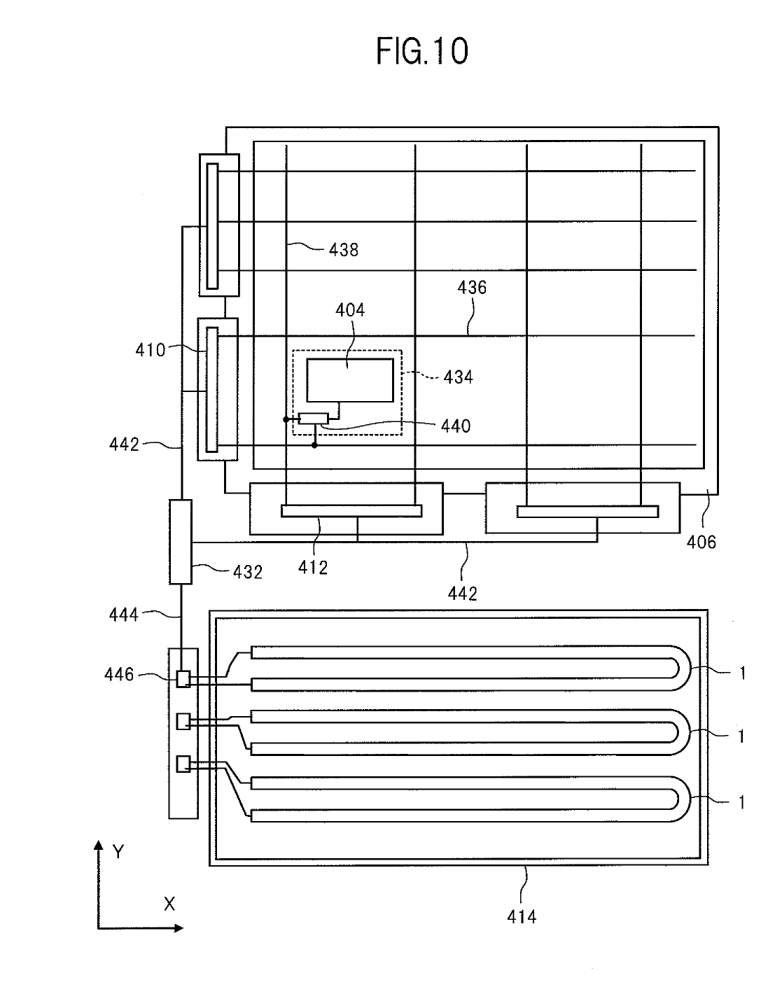

FIG. 9 is an exploded perspective view illustrating a liquid crystal display device according to the embodiment of the present invention. FIG. 10 is a diagram for describing a circuit of the liquid crystal display device according to the embodiment of the present invention. The liquid crystal display device includes a liquid crystal display panel 400 and a backlight 402 including the above-mentioned cold cathode discharge tube 1.

The liquid crystal display panel 400 includes a liquid crystal layer (not shown) held between a substrate 406 having pixel electrodes 404 and another substrate 408. Two sides of the one substrate 406 are projected from the another substrate 408, and the projected portions are connected with driver circuits 410 and 412.

Because the liquid crystal display panel 400 is not a light emitting element, the backlight 402 being a light source is required. The backlight 402 is located on the rear side or front side of the liquid crystal display panel 400 to illuminate the liquid crystal display panel 400 with light.

A reflection sheet 416 is laid within a lower frame 414, and the plurality of cold cathode discharge tubes 1 are located above the reflection sheet 416. The lower frame 414 is formed of a metal plate, and also functions to integrally accommodate the liquid crystal display panel 400 stacked on an optical compensation sheet laminated body 420 in interlocking with an upper frame (not shown) likewise formed of a metal plate.

A light guide plate 422 made of a translucent resin material is located above the backlight 402, and the optical compensation sheet laminated body 420 is located on the light guide plate 422 (below the liquid crystal display panel 400). The optical compensation sheet laminated body 420 is configured by laminating a diffusion plate 423, a first diffusion sheet 424, two prism sheets 426 and 428 intersecting with each other, and a second diffusion sheet 430.

The liquid crystal display device further includes a control circuit 432. A signal necessary for display of the liquid crystal display panel 400 is supplied from the control circuit 432.

Pixel portions 434 are disposed on the liquid crystal display panel 400. The liquid crystal display panel 400 includes a large number of pixel portions 434 arranged in matrix, but for facilitation of understanding, only one pixel portion 434 is illustrated in FIG. 10. The pixel portions 434 arranged in matrix form a display region, and the respective pixel portions 434 serve as pixels of an image, and display an image in the display region.

In FIG. 10, there are disposed gate signal lines 436 (also called “scanning lines”) which extend in an x-direction of FIG. 10 and are arranged in parallel in a y-direction of FIG. 10, and drain signal lines 438 (also called “video signal lines”) which extend in the y-direction and are arranged in parallel in the x-direction. The pixel portion 434 is formed in each of regions surrounded by the gate signal lines 436 and the drain signal lines 438.

A switching element 440 is disposed in each pixel portion 434. A control signal is supplied from the corresponding gate signal line 436 to the switching element 440 to control the on/off operation of the switching element 440. When the switching element 440 is turned on, a video signal transmitted through the corresponding drain signal line 438 is supplied to the pixel electrode 404.

The gate signal lines 436 are connected to the driver circuit 410, and the drain signal lines 438 are connected to the driver circuit 412. The control signal is output from the driver circuit 410, and the video signal is output from the driver circuit 412.

Signal lines 442 are connected to the driver circuits 410 and 412 from the control circuit 432, and the respective driver circuits 410 and 412 are controlled by the control circuit 432. Also, a signal line 444 is connected to the backlight 402 from the control circuit 432.

The control signal and a power supply voltage are supplied to the backlight 402 from the control circuit 432 to light the cold cathode discharge tube 1. The cold cathode discharge tube 1 is connected to an inverter circuit 446, and the inverter circuit 446 develops and applies a voltage for lighting the cold cathode discharge tube 1.

The preset invention is not limited to the above-mentioned embodiment, and various modifications may be made thereto. For example, the configurations described in the above-mentioned embodiment may be replaced with a substantially identical configuration, a configuration having the same operation and effects, or a configuration that may achieve the same purpose.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A manufacturing method for a cold cathode discharge tube, comprising:
preparing a plurality of glass tubes each having a phosphor layer formed on an inner surface thereof and joining the plurality of glass tubes together at ends thereof, to thereby form a bent glass tube having a bent tube portion;
fitting electrodes to both ends of the bent glass tube; and
filling gas inside of the bent glass tube.

2. The manufacturing method for a cold cathode discharge tube according to claim 1, wherein:
the bent glass tube includes a plurality of straight tube portions arranged in parallel to each other; and
the bent tube portion is so formed as to connect a pair of the straight tube portions to each other.

3. The manufacturing method for a cold cathode discharge tube according to claim 2, wherein each of the plurality of glass tubes is prepared in a state where a half of the bent tube portion is adjacent to the end and one of the plurality of straight tube portions is adjacent to the half of the bent tube portion.

4. The manufacturing method for a cold cathode discharge tube according to claim 1, wherein the forming a bent glass tube includes preparing each of the plurality of glass tubes in a straight state, joining two of the plurality of glass tubes together at the ends, and then bending the two joined glass tubes.

5. The manufacturing method for a cold cathode discharge tube according to claim 1, wherein:
the bent glass tube includes a plurality of first straight tube portions arranged in parallel to each other, and a second straight tube portion arranged to extend orthogonally between a pair of the first straight tube portions; and
the bent tube portion is formed to connect each of the pair of first straight tube portions and the second straight tube portion.

6. The manufacturing method for a cold cathode discharge tube according to claim 5, wherein each of the plurality of glass tubes is prepared in a state where a half of the second straight tube portion is adjacent to the end, the bent tube portion is adjacent to the half of the second straight tube portion, and one of the plurality of first straight tube portions is adjacent to the bent tube portion.

7. The manufacturing method for a cold cathode discharge tube according to claim 1, wherein each of the plurality of glass tubes is prepared in a state where the phosphor layer is formed so as to avoid the joined end.

8. A cold cathode discharge tube, comprising:
a bent glass tube having a bent tube portion, the bent glass tube being formed by joining together a plurality of glass tubes each having a phosphor layer formed on an inner surface thereof;
electrodes fitted to both ends of the bent glass tube; and
gas filled inside of the bent glass tube.

9. The cold cathode discharge tube according to claim 8, wherein:
the bent glass tube includes a plurality of straight tube portions arranged in parallel to each other; and
the bent tube portion is so formed as to connect a pair of the straight tube portions to each other.

10. The cold cathode discharge tube according to claim 8, wherein:
the bent tube portion includes a joint portion of a pair of the glass tubes; and
the phosphor layer is formed so as to avoid the joint portion.

11. The cold cathode discharge tube according to claim 8, wherein:
the bent glass tube includes a plurality of first straight tube portions arranged in parallel to each other, and a second straight tube portion arranged to extend orthogonally between a pair of the first straight tube portions; and
the bent tube portion is formed to connect each of the pair of first straight tube portions and the second straight tube portion.

12. The cold cathode discharge tube according to claim 11, wherein:
the second straight tube portion includes a joint portion of a pair of the glass tubes; and
the phosphor layer is formed so as to avoid the joint portion.

13. A liquid crystal display device, comprising:
a liquid crystal display panel; and
a backlight having a cold cathode discharge tube,
wherein the cold cathode discharge tube includes:
a bent glass tube having a bent tube portion, the bent glass tube being formed by joining together a plurality of glass tubes each having a phosphor layer formed on an inner surface thereof;
electrodes fitted to both ends of the bent glass tube; and
gas filled inside of the bent glass tube.

14. The liquid crystal display device according to claim 13, wherein:
the bent glass tube includes a plurality of straight tube portions arranged in parallel to each other; and
the bent tube portion is so formed as to connect a pair of the straight tube portions to each other.

15. The liquid crystal display device according to claim 14, wherein:
the bent tube portion includes a joint portion of a pair of the glass tubes; and
the phosphor layer is formed so as to avoid the joint portion.

16. The liquid crystal display device according to claim 13, wherein:
the bent glass tube includes a plurality of first straight tube portions arranged in parallel to each other, and a second straight tube portion arranged to extend orthogonally between a pair of the first straight tube portions; and
the bent tube portion is formed to connect each of the pair of first straight tube portions and the second straight tube portion.

17. The liquid crystal display device according to claim 16, wherein:
the second straight tube portion includes a joint portion of a pair of the glass tubes; and
the phosphor layer is formed so as to avoid the joint portion.
